(19) United States
(12) Patent Application Publication
(10) Pub. No.: US 2021/0127835 A1
(43) Pub. Date: May 6, 2021

(54) TOOL-FREE DISMOUNTABLE FURNITURE

(71) Applicant: FOSHAN SIRIO HOME AND GARDEN FURNISHING INC., Foshan, Guangdong (CN)

(72) Inventors: Bin SONG, Foshan, Guangdong (CN); Runxiang GUO, Foshan, Guangdong (CN)

(21) Appl. No.: 16/487,181

(22) PCT Filed: Jun. 6, 2018
(86) PCT No.: PCT/CN2018/090124

§ 371 Date: Aug. 20, 2019

(30) Foreign Application Priority Data
Dec. 11, 2017 (CN) 201721711344.9

(51) Int. Cl. A47C 4/02; F16B 12/10

(52) U.S. Cl. CPC A47C 4/02; F16B 12/10

(57) ABSTRACT

Systems and methods are provided for tool-free dismountable furniture. An exemplary system (100) includes a plurality of primary connectors and a plurality of secondary connectors which connect parts of an armchair. The system (100) includes a backrest (104) with a first pair of primary connectors on a top portion and a second pair of primary connectors on a bottom portion. These primary connectors connect to secondary connectors on a rear end of a set of handrails (112,114). The handrails (112,114) also have primary connectors on a front end which connect to secondary connectors on a seat board (102).

### CROSS-REFERENCE TO RELATED APPLICATIONS

This application claims priority to and the benefit of Chinese Patent Application No. 201721711344.9, filed Dec. 11, 2017 and entitled “Tool-free Dismountable Furniture.” The contents of this application are hereby incorporated by reference in their entirety as if fully set forth herein.

### FIELD OF THE INVENTION

The present invention relates to furniture fixings, and more specifically to systems and methods for tool-free dismountable furniture.

### BACKGROUND

Furniture can either be assembled before transportation to its destination of after transportation. In instances where the destination is a consumer's residence, there can be several challenges with either option. If furniture is assembled before transportation to the consumer's residence, careful packaging is needed to ensure the assembled furniture will not be damaged during its transportation route. Assembled furniture is generally large, and the packaging needed to protect the assembled furniture is larger still. This increases the cost of transportation to the destination and increases the cost of any storage needed along the way.

Alternatively, furniture can be assembled after arrival at its destination. Furniture assembled after its destination either require professional installation or many parts that the consumer must assemble. Requiring professional installation to install furniture can be costly, require additional tools, and take up valuable consumer time. On the other hand, if the consumer is required to assemble the furniture based on many parts and pieces, it is easy for the pieces to become mixed up and the consumer to incorrectly assemble the furniture. This can lead to damage to the furniture or to inoperability of the furniture. Additionally, the consumer might discover that there are missing or damaged connecting pieces during the consumer's attempt to assemble the furniture. This also can lead to inoperability of the furniture because the consumer will not be able to assemble the furniture due to the missing parts.

Therefore, what is needed is a new system and method for assembling furniture which does not require tools and can be constructed with a minimum of additional parts. The additional parts should be standardized so that the consumer does not accidentally use an incorrect tool.

### SUMMARY

The various examples of the present disclosure are directed towards a system for tool-free dismountable furniture. The system includes a plurality of primary connectors and a plurality of secondary connectors which can be used to connect parts of an armchair. The armchair can include a backrest, wherein a first pair of primary connectors are on opposite ends of a top portion of the backrest and a second pair of primary connectors can be on the opposite ends of a bottom portion of the backrest. The armchair can also include a seat board wherein two of the plurality of secondary connectors are affixed to the seat board. A pair of handrails can connect the seat board and the backrest. Each of the pair of handrails can have two of the plurality of the secondary connectors affixed to the rear portion of the handrail and configured to connect to two of the primary connectors on the backrest. Each handrail can also have a primary connector affixed to a front portion of each handrail and configured to connect to the secondary connectors affixed to the seat board.

In one embodiment, the primary connectors can comprise a plurality of buckles, wherein each buckle comprises a buckle latch connected to a buckle stand. The corresponding secondary connectors can comprise hooks, wherein each hook is a trapezoidal connector made of an incurved plate, configured to receive the latch of one of the plurality of buckles.

In a second embodiment, the primary connectors can comprise fixed adapters, wherein each fixed adapter is a rectangular shape with a cutout portion, wherein a length of the cutout portion is a fixed distance. The corresponding secondary connectors can comprise supporting adapters configured as a rectangular shape with a cutout portion configured to receive a fixed adapter. The width of the cutout portion can be slightly larger then the length of the cutout portion in the fixed adapters.

In some examples, the secondary connectors on the seat boards can be hooks and the primary connectors on the front portion of the handrails are buckles. The first pair of primary connectors on the backrest can be fixed adapters and the second pair of primary connectors on the backrest can be buckles. The secondary connectors on the handrails which connect to the first pair of primary connectors on the backrest can be supporting adapters and the secondary connectors on the handrails which connect to the second pair of primary connectors on the backrest can be hooks.

In some examples, all of the primary connectors in the armchair system can be buckles and all of the secondary connectors in the armchair system can be hooks.

In some examples, all of the primary connectors in the armchair system can be fixed adapters and all of the secondary connectors in the armchair system can be supporting adapters.

In other examples, the primary connectors in the armchair system can be any combination of buckles and fixed adapters, where the secondary connectors in the armchair system correspond to the combination of buckles and fixed adapters.

Additional pairs of primary and secondary connectors beyond those listed can provide structural support for the armchair system.

### BRIEF DESCRIPTION OF THE DRAWINGS

FIG. 1 shows a schematic drawing of an exemplary armchair system according to an embodiment of the present disclosure.

FIG. 2 shows a schematic drawing of an exemplary buckle and hook assembly according to an embodiment of the present disclosure.

FIG. 3 shows a schematic drawing of an exemplary connection using a buckle and hook assembly between a backrest and a handrail of a chair system according to an embodiment of the present disclosure.

FIG. 4 shows a schematic drawing of an exemplary fixed adapter and supporting adapter according to an embodiment of the present disclosure.

FIG. 5 shows a schematic drawing of an another exemplary connection using a fixed adapter and supporting adapter between a backrest and a handrail of a chair system according to an embodiment of the present disclosure.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The present disclosure provides for a plurality of primary connectors and a plurality of secondary connectors to connect parts of an armchair. For example, a backrest can have a first pair of primary connectors on a top portion and a second pair of primary connectors on a bottom portion. These primary connectors connect to secondary connectors on the rear end of a set of handrails. The handrails can also have primary connectors on a front end which connect to secondary connectors on a seat board. Primary connectors can be buckles comprised of buckle latches connected to buckle stands. Corresponding secondary connectors can be hooks configured to connect to the buckles. A second embodiment of the primary connectors can be fixed adapters configured as a rectangular shape with a cutout portion to receive supporting adapters as secondary connectors which have similar shapes. Any combination of primary connectors and their corresponding secondary connectors can connect parts of the armchair.

The present disclosure allows for simplicity of assembly because the consumer does not need to procure extra tools in order to assemble the furniture. The connectors as provided for in the present disclosure rectify the absence of hardware parts when the consumer receives the furniture. Additionally, human error during installation is reduced because there is a much lower likelihood that the consumer could use the wrong parts for installation. Installation time for the furniture is reduced. With the present disclosure, one person can easily install the full set of furniture without any extra tools. A single person installation can assemble the armchair in less than five minutes whereas contemporary systems might take more than thirty minutes to assemble. Assembly is therefore faster and easier than in previous systems. All of these factors reduce inconvenience to the customers and provide a corresponding better customer service from the manufacturer who has a higher ability to help the consumer with installation.

Additionally, this system lowers the costs of transportation and storage because the furniture can be easily disassembled and stored compactly.

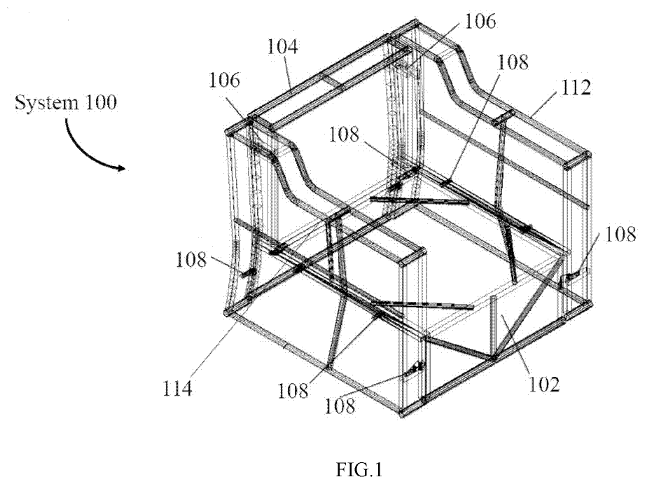

FIG. 1 shows an exemplary tool-free dismountable chair system 100 according to an embodiment of the present disclosure. The chair system 100 includes a seat board 102; a backrest 104; adapter assembly 106; buckle and latch assembly 108; left handrail 112; and right handrail 114. The seat board 102 is connected to the left handrail 112 and the right handrail 114 and is configured to support the weight of a user. The left handrail 112 and right handrail 114 are also connected to the backrest 104 and provide additional structural support for the armchair as well as a place where the user can place their arms. The backrest 104 provides a location for the user to lean against when sitting in the armchair.

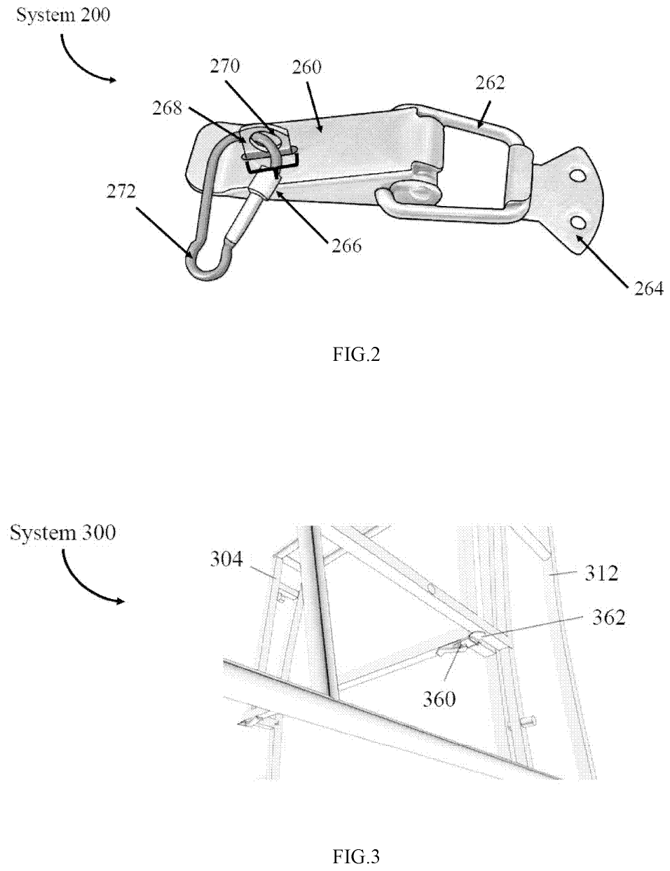

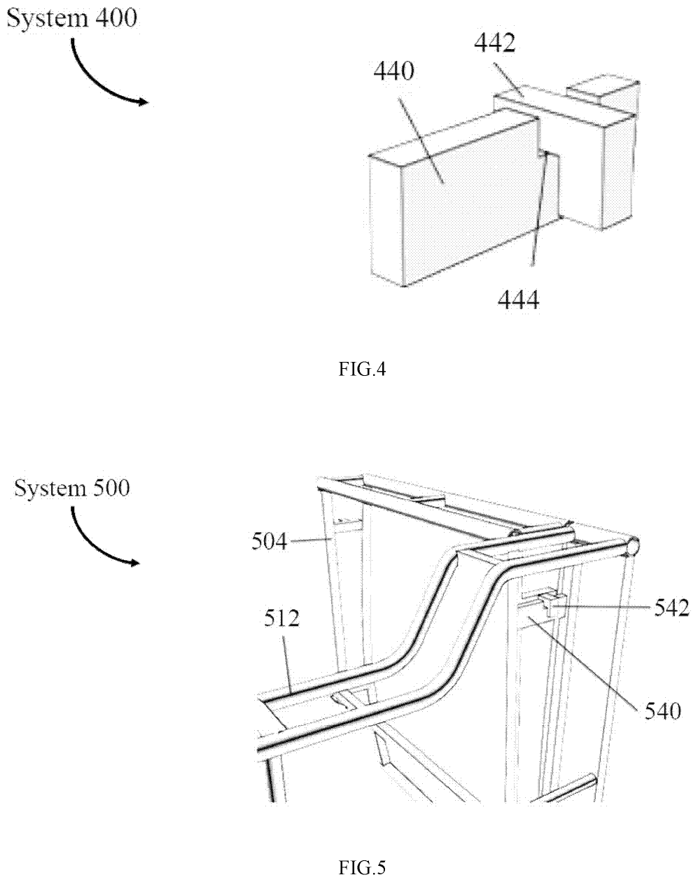

The seat board 102, the backrest 104, the left handrail 112, and the right handrail 114 can all be connected to each other in a variety of methods. In the embodiment depicted, these elements are connected to each other via primary and secondary connectors. One example is the buckle and latch assembly 108 which connects a lower portion of the left handrail 112 and right handrail 114 to the backrest 104. The buckle and latch assembly is discussed further with regards to FIGS. 2-3. Referring back to FIG. 1, another example of primary and secondary connectors is the adapter assembly 106 which connects an upper portion of the left handrail 112 and right handrail 114 to the backrest 104. The adapter assembly is discussed further with regards to FIGS. 4-5.

Although a particular ratio of buckle and latch assemblies to adapter assemblies is shown in FIG. 1, any ratio of buckle and latch assemblies to adapter assemblies can be used to stabilize and assemble the armchair system 100.

Although only six pairs of primary and secondary connectors are shown in FIG. 1, any number of primary and secondary connectors can be used to stabilize and assemble the armchair system 100.

Although particular locations of primary and secondary connectors are shown in FIG. 1, the primary and secondary connectors can be placed anywhere on the armchair system 100 so long as the backrest 104 is connected to the left handrail 112 and right handrail 114 and the seat board 102 is connected to the left handrail 112, and the right handrail 114.

FIG. 2 shows an exemplary buckle and latch assembly 200 according to an embodiment of the present disclosure. The buckle and latch assembly 200 includes a buckle stand 260; a buckle latch 262; a buckle hook 264; a stand opening 266; a stand protrusion 268; a protrusion opening 270; and a carabineer 272. The buckle stand 260 is the part of the buckle and latch assembly 200 which secures the assembly 200 to a chair component. For example, the buckle stand 260 can be fixed onto the seat board 102, the backrest 104, the left handrail 112, or the right handrail 114. The buckle latch 262 can be configured to receive the buckle hook 264 and provide a secure attachment. The buckle latch 262 can be a circular or rectangular shape which is open in the center to receive the buckle hook 264. The buckle latch 262 can also be any closed polygonal shape with an open middle to receive the buckle hook 264. The buckle hook 264 can be a trapezoidal connector made of an incurved steel plate, configured to receive the latch of a buckle.

The buckle and latch assembly 200 functions to lock two separate components into place. The assembly 200 will lock into place whatever the buckle hook 264 is attached to and whatever the buckle latch 262 is attached to. For example, the buckle hook 264 can be attached to a seat board 102 and the buckle latch 262 can be attached to a backrest 104. When the buckle latch 262 has received the buckle hook 264, a secure attachment will be formed between the buckle latch 262 and the buckle hook 264 such that the seat board 102 and the backrest 104 are securely connected to each other.

The buckle latch 262 can additionally have an opening through which a stand protrusion 268 can extend. The stand protrusion 268 can be configured with a protrusion opening 270. The protrusion opening 270 can receive another element; for example, the protrusion opening 270 can receive a carabineer 272. The carabineer 272 can prevent lock the assembly 200 in place so that the buckle latch 262 cannot move to release the buckle hook 264 unless the carabineer 272 is removed.

The buckle and latch assembly 200 can be made of steel, a metal, plastic, or another durable material.

FIG. 3 shows an exemplary buckle and latch assembly chair system 300 according to an embodiment of the present disclosure. The buckle and latch assembly chair system 300 includes a backrest 304; a left handrail 312; a buckle latch 360; and a buckle hook 362. FIG. 3 shows an exemplary connection between a backrest 304 and a left handrail 312 according to an embodiment of the present disclosure. In this embodiment, the buckle latch 360 is connected to a buckle stand (not pictured) on the backrest 304. The buckle hook 362 is connected to the left handrail 312. The buckle latch 360 is further connected to the buckle hook 362 which secures the left handrail 312 to the backrest 304. Therefore, FIG. 3 shows an exemplary connector system using a buckle and latch assembly as shown in FIG. 2.

FIG. 4 shows an exemplary adapter assembly 400 according to an embodiment of the present disclosure. The adapter assembly system 400 includes a fixed adapter 440; supporting adapter 442; and cutout portion 444. The fixed adapter 440 comprises a rectangular shape with a cutout portion 444. The cutout portion 444 has a length of a set distance. The supporting adapter 442 also comprises a rectangular shape with a cutout portion 444. The width of the cutout portion 444 of the supporting adapter 442 can slightly larger than the length of the cutout portion 444 of the fixed adapter 440. This allows the cutout portions of the fixed adapter 440 and the supporting adapter 442 to receive each other and form a secure attachment. Additionally, the depth of the cutout portion 444 can be properly aligned so that the fixed adapter 440 and the supporting adapter 442 can lie flush with each other when receiving each other.

In some embodiments, the fixed adapter and the supporting adapter can be identically shaped. The fixed adapter and the supporting adapter can be made from wood, plastic, metal, or any other durable material.

FIG. 5 shows an exemplary adapter accessory chair system 500 according to an embodiment of the present disclosure. The adapter accessory chair system 500 includes a backrest 504; a left handrail 512; a fixed adapter 540; and a supporting adapter 542. FIG. 5 shows an exemplary connection between a backrest 504 and a left handrail 512 according to an embodiment of the present disclosure. In this embodiment, the fixed adapter 540 is connected to the supporting adapter 542 but placing the cutout portions (not pictured) of the connectors directly on top of each other. The fixed adapter 540 is connected to the left handrail 512 and the supporting adapter 542 is connected to the backrest 504. Therefore, by the connection of the fixed adapter 540 and the supporting adapter 542, the backrest 504 is securely connected to the left handrail 512.

While various examples of the present invention have been described above, it should be understood that they have been presented by way of example only, and not limitation. Numerous changes to the disclosed examples can be made in accordance with the disclosure herein without departing from the spirit or scope of the invention. Thus, the breadth and scope of the present invention should not be limited by any of the above described examples. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular examples only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A system for a tool-free dismountable armchair, comprising:
a plurality of primary connectors and a plurality of secondary connectors;
a backrest, wherein a first pair of primary connectors are on opposite ends of a top portion of the backrest and wherein a second pair of primary connectors are on opposite ends of a bottom portion of the backrest;
a seat board, wherein two of the plurality of secondary connectors are affixed to the seat board;
a pair of handrails, wherein two of the plurality of secondary connectors are affixed to a rear portion of each handrail and configured to connect to the primary connectors affixed to the backrest and wherein one of the plurality of primary connectors is affixed to a front portion of each handrail and configured to connect to the secondary connectors affixed to the seat board.

2. The system of claim 1, wherein some of the plurality of primary connectors comprise a plurality of buckles, wherein a buckle further comprises a buckle latch connected to a buckle stand.

3. The system of claim 2, wherein some of the plurality of secondary connectors comprise a plurality of hooks, wherein a hook further comprises a trapezoidal connector made of an incurved plate, configured to receive the latch of one of the plurality of buckles.

4. The system of claim 3, wherein some of the plurality of primary connectors further comprise a plurality of fixed adapters, wherein a fixed adapter further comprises a rectangular shape with a cutout portion, wherein a length of the cutout portion is a fixed distance.

5. The system of claim 4, wherein some of the plurality of secondary connectors further comprise a plurality of supporting adapters, wherein a supporting adapter is a rectangular shape configured to receive a fixed adapter in a cutout portion, wherein a width of the cutout portion is slightly larger than the fixed distance of length of the cutout portion in the fixed adapters.

6. The system of claim 5, wherein the secondary connectors on the seat board are comprised of hooks and wherein the primary connectors on the front portion of the handrails are buckles.

7. The system of claim 6, further comprising:
fixed adapters as the first pair of primary connectors on the backrest;
buckles as the second pair of primary connectors on the backrest;
supporting adapters as the secondary connectors on the handrails which connect to the first pair of primary connectors on the backrest; and
hooks as the secondary connectors on the handrails which connect to the second pair of primary connectors on the backrest.

8. The system of claim 3, wherein all of the primary connectors in the armchair system are buckles and all of the secondary connectors in the armchair system are hooks.

9. The system of claim 5, wherein all of the primary connectors in the armchair system are fixed adapters and all of the secondary connectors in the armchair system are supporting adapters.

10. The system of claim 5, wherein the primary connectors in the armchair system are any combination of buckles and fixed adapters and wherein the secondary connectors in the armchair system correspond to the combination of buckles and fixed adapters.
